(19) United States
(12) Patent Application Publication
(10) Pub. No.: US 2009/0327094 A1
(43) Pub. Date: Dec. 31, 2009

(54) PLATFORM INDEPENDENT ECOSYSTEM FOR CREATION, CONSUMPTION AND TRADE OF USER-GENERATED DIGITAL CONTENT

(75) Inventors: Jean-Emile Elien, Bellevue, WA (US); Ling Tony Chen, Bellevue, WA (US); Ryan B. Cooper, Kirkland, WA (US); Shyam Krishnamoorthy, Kirkland, WA (US); Gennady Medvinsky, Redmond, WA (US); Gregory D. Hartrell, Sammamish, WA (US); Ramesh Nagarajan, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: MICROSOFT CORPORATION, Redmond, WA (US)

(21) Appl. No.: 12/165,399

(22) Filed: Jun. 30, 2008

(51) Int. Cl. G06Q 30/00; G06F 21/00

(52) U.S. Cl. 705/26; 726/3

(57) ABSTRACT

A platform (e.g. game console) and application (e.g. game title) independent ecosystem for the creation, consumption and trade of user generated digital content permits any application operating on any platform to participate in a market driven economy for user generated digital objects (UGDOs). The trading system is independent of (i.e. external to) all participating applications. A metadata attribution method for UGDOs in combination with heterogeneous application support through well-defined interfaces facilitates unlimited participation. Attributed metadata may be understood and consumed across platforms and applications. Flexible UGDO rights enforcement techniques in combination with a flexible fair exchange service for those rights support all manner of UGDOs and commercial transactions therefore. Participating application may provide rights enforcement in some instances. The nature of enforcement may rest on the nature of UGDO content, rights in UGDOs or author preferences. The trading system assures that all transactions in the UGDO economy are secure, fault tolerant and atomic, providing integrity and confidence in the UGDO economy.

### TECHNICAL FIELD

The technical field relates generally to user-generated digital content and, more specifically, to a platform independent ecosystem for the creation, consumption and trade of user generated digital content.

### BACKGROUND

With the advent of Web 2.0 technology, Internet users are better able to participate in the creation and dissemination of digital content. Their personalized virtual assets are represented by a variety of user generated digital objects (UGDOs). UGDOs may take many forms. For example, a UGDO may be a customized avatar representing an alter ego for an interactive environment such as Second Life™ (Second Life is a registered trademark of Linden Research, Inc., 945 Battery Street, San Francisco Calif. 94111), a game specific object such as a quest sword serving as a status symbol of skill in a gaming community, an XNA game developed by a hobbyist, a personal video, etc. XNA™ is a registered trademark of Microsoft Corporation, One Microsoft Way, Redmond, Wash. 98052. UGDOs have varying levels of value to their creators and others, but tend to be shared, publicly or amongst friends, due to the lack of a market environment promoting exchange, barter and trade among producers and consumer of UGDOs.

The UGDO economy is limited by numerous factors. While tools for generating and distributing some types of UGDOs have emerged, producers of UGDOs generally have no systematic means of obtaining compensation for their works. They remain generally limited to distributing their digital assets for free. YouTube™ and the XNA Creator's Club are two examples of such free distribution. YouTube is a registered trademark of Google, Inc., 1600 Amphitheatre Parkway, Mountain View, Calif. 94043. There are a few systems that facilitate exchanges of UGDOs, but exchanges are limited to UGDOs of a specific variety. StaionExchange™ is one such example. Station Exchange is a registered trademark of Sony Online Entertainment Inc., 10202 W. Washington Blvd., Culver City, Calif. 90232. StaionExchange™ provides an in-game auction system only for user-generated game characters, i.e. game-specific objects, for the EverQuest™ II game. Everquest is a registered trademark of Sony Online Entertainment LLC, 10202 W. Washington Blvd., Culver City, Calif. 90232. The auction system does not even apply to prior versions of the game let alone other game titles or the wide variety of UGDOs. Thus, the UGDO economy is severely limited.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

Described herein is a platform (e.g. hardware and operating system—game console) and application (e.g. game title) independent ecosystem for the creation, consumption and trade of user generated digital content. In this ecosystem, any application operating on any platform can participate in the market for UGDOs. A metadata attribution method facilitates participation by a wide variety of applications and platforms in the UGDO economy. Flexible ownership or other rights enforcement techniques in combination with a fair exchange service provide for integrity and confidence in the UGDO economy. The trading system is independent of (i.e. external to) all other applications (e.g. game titles). The trading system provides heterogeneous application support by offering well-defined programming interfaces so that any application can participate in the trading system.

A metadata attribution methodology is applied to UGDOs when they are ingested into the trading system to describe digital objects created by certain applications so that the objects may be reused by other applications. This adds value for UGDO producers, application developers and consumers by expanding the marketability/applicability of digital property to additional applications and consumers. While UGDOs may be application specific, metadata attributed to them is not, permitting wide participation in the UGDO economy.

A fair exchange service in the trading system permits a wide variety of transactions to expand the marketability of digital property. The trading system supports flat fee purchases, licensing, auctions, bartering, trades, etc. The trading system assures that all varieties of the UGDO economy are secure, fault tolerant and atomic. The trading system also supports fair exchanges for transactions involving more than two parties.

A UGDO ownership or other rights enforcement model provides flexible enforcement rules. The nature of enforcement may depend on the nature of UGDO content. Digital Rights Management (DRM) techniques may be applied to passive content (e.g. music, video) mainly used offline or requiring participation of only one consumer, as opposed to interactive content (e.g. an avatar in a multi-player game). In contrast, a server-controlled ownership model may be used for active content. A server agent (e.g. in applications) may perform access control checks per user prior to UGDO access and/or use.

There are numerous advantages to a platform independent ecosystem for the creation, consumption and trade of user generated digital content. For example, a platform independent ecosystem for the creation, consumption and trade of user generated digital content provides a common platform to enable everyone to participate in the generation, publication and commercialization of UGDOs irrespective of their application or the platform on which it operates. Attributed metadata may be understood and consumed across platforms and applications. Applications may interact with an object's metadata rather than the object itself. This creates a true economy in UGDOs, in contrast to splintered platform, application and/or version specific systems. All manner of portals may be built atop this multi-purpose trading system, each of which may but need not be platform and application independent. Flexible exchanges and flexible enforcement make the system universal for all UGDOs.

### BRIEF DESCRIPTION OF THE DRAWINGS

The foregoing summary, as well as the following detailed description, is better understood when read in conjunction with the appended drawings. For the purpose of illustrating a platform independent ecosystem for the creation, consumption and trade of user generated digital content, there is shown in the drawings exemplary constructions thereof, however, a platform independent ecosystem for the creation, consumption and trade of user generated digital content is not limited to the specific methods and instrumentalities disclosed.

FIG. 1 is a block diagram of an exemplary open computing environment in which various aspects of a platform independent ecosystem for the creation, consumption and trade of user generated digital content can be implemented.

FIG. 2 is a block diagram of an exemplary closed computing environment in which various aspects of a platform independent ecosystem for the creation, consumption and trade of user generated digital content can be implemented.

FIG. 3 is a diagram illustrating various aspects of a platform independent ecosystem for the creation, consumption and trade of user generated digital content in accordance with one embodiment thereof.

FIG. 4 is a content ingestion flow diagram illustrating various aspects of a platform independent ecosystem for the creation, consumption and trade of user generated digital content in accordance with one embodiment thereof.

FIG. 5 is an exchange flow diagram illustrating various aspects of a platform independent ecosystem for the creation, consumption and trade of user generated digital content in accordance with one embodiment thereof.

FIG. 6 is a rights verification flow diagram illustrating various aspects of a platform independent ecosystem for the creation, consumption and trade of user generated digital content in accordance with one embodiment thereof.

### DETAILED DESCRIPTION OF ILLUSTRATIVE EMBODIMENTS

Reference will now be made in detail to embodiments of the present technology for a platform independent ecosystem for the creation, consumption and trade of user generated digital content, examples of which are illustrated in the accompanying drawings. While the technology for a platform independent ecosystem for the creation, consumption and trade of user generated digital content will be described in conjunction with various embodiments, it will be understood that they are not intended to limit the present technology to these embodiments. On the contrary, the presented technology for a platform independent ecosystem for the creation, consumption and trade of user generated digital content is intended to cover alternatives, modifications, and equivalents, which may be included within the spirit and scope the various embodiments as defined by the appended claims. Furthermore, in the following detailed description, numerous specific details are set forth in order to provide a thorough understanding of the present technology for a platform independent ecosystem for the creation, consumption and trade of user generated digital content. However, the present technology for a platform independent ecosystem for the creation, consumption and trade of user generated digital content may be practiced without these specific details. In other instances, well known methods, procedures, components, and circuits have not been described in detail as not to unnecessarily obscure aspects of the present embodiments.

Unless specifically stated otherwise as apparent from the following discussions, it is appreciated that throughout the present detailed description, discussions utilizing terms such as “opening”, “determining”, “sequencing”, “reading”, “loading”, “overriding”, “writing”, “creating”, “including”, “comparing”, “receiving”, “providing”, “generating”, “associating”, and “arranging”, or the like, refer to the actions and processes of a computer system or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The present technology for a platform independent ecosystem for the creation, consumption and trade of user generated digital content is also well suited to the use of other computer systems such as, for example, optical and mechanical computers. Additionally, it should be understood that in embodiments of the present technology for a platform independent ecosystem for the creation, consumption and trade of user generated digital content, one or more of the steps can be performed manually.

The present invention provides for a platform (e.g. hardware and operating system—game console) and application (e.g. game title) independent ecosystem for the creation, consumption and trade of user generated digital content. In this ecosystem, any application operating on any platform can participate in the market for UGDOs. A metadata attribution method facilitates participation by a wide variety of applications and platforms in the UGDO economy. Flexible ownership or other rights enforcement techniques in combination with a fair exchange service provide for integrity and confidence in the UGDO economy. The trading system is independent of (i.e. external to) all other applications (e.g. game titles). The trading system provides heterogeneous application support by offering well-defined programming interfaces so that any application can participate in the trading system.

A metadata attribution methodology is applied to UGDOs when they are ingested into the trading system to describe digital objects created by certain applications so that the objects may be reused by other applications. This adds value for UGDO producers, application developers and consumers by expanding the marketability/applicability of digital property to additional applications and consumers. While UGDOs may be application specific, metadata attributed to them is not, permitting wide participation in the UGDO economy.

A fair exchange service in the trading system permits a wide variety of transactions to expand the marketability of digital property. The trading system supports flat fee purchases, licensing, auctions, bartering, trades, etc. The trading system assures that all varieties of the UGDO economy are secure, fault tolerant and atomic. The trading system also supports fair exchanges for transactions involving more than two parties.

A UGDO ownership or other rights enforcement model provides flexible enforcement rules. The nature of enforcement may depend on the nature of UGDO content. Digital Rights Management (DRM) techniques may be applied to passive content (e.g. music, video) mainly used offline or requiring participation of only one consumer, as opposed to interactive content (e.g. an avatar in a multi-player game). In contrast, a server-controlled ownership model may be used for active content. A server agent (e.g. in applications) may perform access control checks per user prior to UGDO access and/or use.

Exemplary Open Computing Environment

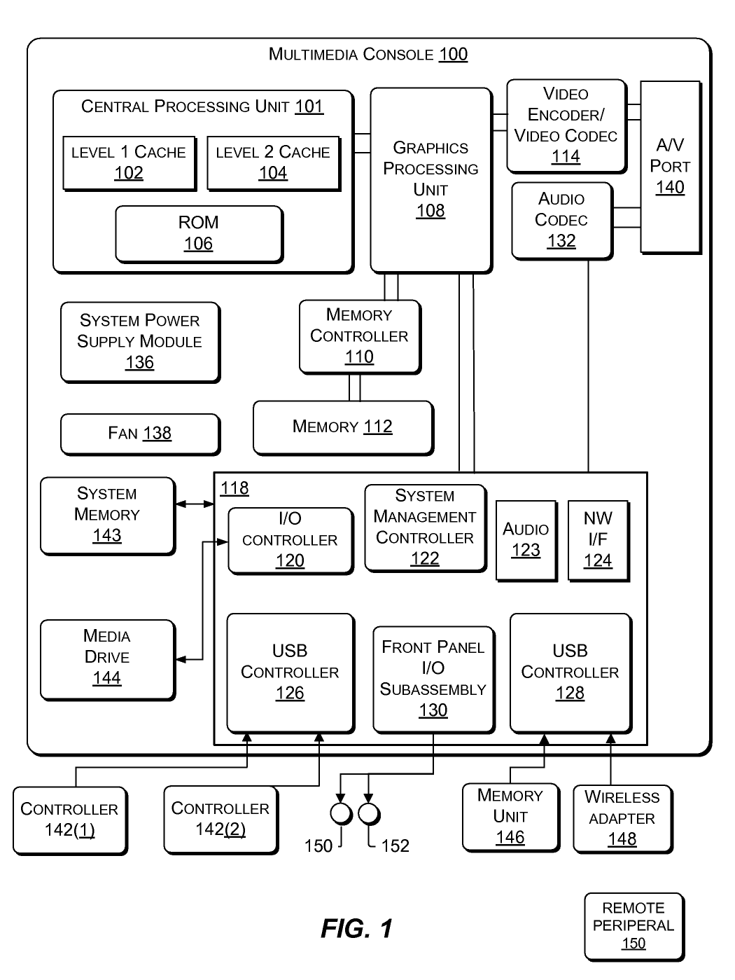

FIG. 1 is a block diagram of an exemplary open computing environment in which various aspects of a platform independent ecosystem for the creation, consumption and trade of user generated digital content can be implemented. For purposes of simplicity, not all components or interconnectivity are shown and some components have been merged into other components shown in FIG. 1. Although categorization may vary in degree from one system to the next, open computing environments are general purpose computing environments that may execute virtually any program while closed systems tend to be more specialized with one or more specific purpose(s) designed to execute, perhaps in addition to general programs, privileged programs specifically created for them. Examples of closed systems may include, for example, cable set top boxes, smart phones, gaming consoles and cellular telephones. Although not required, various aspects of a platform independent ecosystem for the creation, consumption and trade of user generated digital content can be described in the general context of computer executable instructions, such as program modules, being executed by a personal computer, client workstation, server or other computing system. Generally, program modules include routines, programs, objects, components, data structures and the like that perform particular tasks or implement particular abstract data types. Moreover, implementation of a platform independent ecosystem for the creation, consumption and trade of user generated digital content can be practiced with other computer system configurations, including hand held devices, multi processor systems, microprocessor based or programmable consumer electronics, network PCs, minicomputers, mainframe computers, and the like. Further, a platform independent ecosystem for the creation, consumption and trade of user generated digital content also can be practiced in distributed computing environments where tasks are performed by remote processing devices that are linked through a communications network. In a distributed computing environment, program modules can be located in both local and remote memory storage devices.

A computer system can be roughly divided into three component groups: the hardware component, the hardware/software interface system component, and the application programs component (also referred to as the “user component” or “software component”). In various embodiments of a computer system the hardware component may comprise central processing unit (CPU) 120, memory (both ROM 111 and RAM 113), various input/output (I/O) devices such as keyboard 152, mouse 151, display 126, and/or printer (not shown), among other components. To some degree, initialization firmware such as basic input/output system (BIOS) 112 may be considered part of the hardware component as well as part of the hardware/software interface system component. The hardware component comprises the basic physical infrastructure for the computer system.

The application programs component comprises various software programs including but not limited to compilers, database systems, word processors, business programs, video games, and so forth. Application programs provide the means by which computer resources are utilized to solve problems, provide solutions, and process data for various users (machines, other computer systems, and/or end-users).

The hardware/software interface system component comprises (and, in some embodiments, may solely consist of) an operating system that itself comprises, in most cases, a shell and a kernel. As previously noted, firmware such as BIOS may also be considered part of the hardware/software interface system. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. In addition to performing initialization tasks, depending on the system BIOS may also provide some level of interface between hardware and software that isn't performed by the operating system. A purpose of a hardware/software interface system is to provide an environment in which a user can execute application programs.

The hardware/software interface system is generally loaded into a computer system during initialization and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components or their device drivers and/or the BIOS.

As shown in FIG. 1, an exemplary open computing environment in which various aspects of a platform independent ecosystem for the creation, consumption and trade of user generated digital content can be implemented includes a conventional computing device 105 or the like, including processing unit 120, system memory 110, and system bus 165 that couples various system components including system memory 110 to processing unit 120. Computing device 105 may be any variety of computing device such as, but not limited to, a personal computer, laptop, hand-held computer, cellular phone or server. Processing unit 120 may comprise, for example, a CPU, Northbridge and Southbridge chipset with their well-known functionality, among other components. System bus 165 may be any one or all of several types of bus structures including a memory bus, peripheral bus and a local bus using any of a variety of bus architectures. System memory 110 includes read only memory (ROM) 111 and random access memory (RAM) 113. Basic input/output system (BIOS) 112, containing basic routines that help to transfer information between elements within the computing device 105, such as during initialization, is stored in ROM 111. Among other functionality such as a power on self test or POST as it is commonly known, BIOS 112 may include a computer initialization program such as a boot loader stage to load other initialization stages or load and turn over control to operating system 114. While the only BIOS shown is BIOS 112, some hardware devices such as optical drives may have their own BIOS or other necessary initialization firmware, which may be executed in addition to BIOS 112 during initialization of computing device 105. ROM 111 may include embedded memory, e.g., within the CPU of processing unit 120, and/or one or more discrete non volatile memory devices, including flash memory.

Computing device 105 may further include hard disk drive 136 for reading from and writing thereto operating system 114, application programs 115, other programs 116, program data 117 or other information, magnetic disk drive 141 (e.g. floppy disk drive) for reading from or writing to removable storage 142 or other magnetic disk operating system 114, application programs 115, other programs 116, program data 117 or other information, and optical disk drive 146 for reading from or writing to removable optical disk 147, such as a CD ROM or other optical media, operating system 114, application programs 115, other programs 116, program data 117 or other information. Hard disk drive 136, magnetic disk drive 141, and optical disk drive 146 are connected to system bus 165 by a hard disk drive interface 135, magnetic disk drive interface 140, and optical disk drive interface 145, respectively. The exemplary environment of FIG. 1 also includes universal serial bus (USB) controller 130, USB 131 and USB device 132 (e.g. removable USB flash memory or hard disk drive). USB device 132 is coupled to system bus 165 via universal serial bus 131 and USB controller 130. The drives and their associated computer readable media provide non volatile storage of computer executable instructions, data structures, program modules and other data for computing device 105. Similarly, USB device 132 may also comprise removable non-volatile memory such as a USB flash or hard drive, among a host of other devices. Although the exemplary environment described herein employs hard disk 136, removable magnetic disk 142, removable optical disk 147 and removable USB device 132, it is well-known that a computing system may employ many other types of fixed and removable, volatile and non-volatile computer readable media. Likewise, the exemplary environment may also include many types of monitoring devices such as heat sensors and security or fire alarm systems, and other sources of information.

Data and any number of program modules comprising computer-executable instructions, such as BIOS 112 or other initialization program, operating system 114, application programs 115, other program modules 116 and data such as program data 117, can be stored on any one or more computer-readable mediums such as hard disk drive 136, magnetic disk 142, optical disk 147, ROM 111 (e.g. ROM, EEPROM, flash memories, eFuses), USB device 132, RAM 113 or any other discrete or embedded, volatile or non-volatile memories (not shown). A user may enter commands and information into computing device 105 through input devices such as keyboard 152 and a pointing device such as mouse 151. A wide variety of other input devices (not shown) may include, for example, a microphone, joystick, game pad, tablet or scanner. These and other input devices are often connected to processing unit 120 through a serial port interface 150 that is coupled to system bus 165, but may be connected by other wired or wireless interfaces, such as a parallel port, game port, universal serial bus (USB) or Firewire. Display 126 or other type of display device is also connected to system bus 165 via an interface such as graphics controller 125. In addition to display 126, computing devices typically include other peripheral output devices, such as speakers and printers (not shown).

Computing device 105 may operate in a local and/or wide area network environment using logical connections to one or more remote computers, such as remote computer(s) 160. Remote computer(s) 160 may be another computing device (e.g., personal computer), a server, a router, a network PC, a peer device, or other common network node, and typically includes many or all of the hardware, firmware and software elements described above relative to computing device 105. The logical connections depicted in FIG. 1 include a local area network (LAN) 161 and wide area network (WAN) 162 such as the Internet. Such networking environments are commonplace in offices, enterprise wide computer networks, intranets and the Internet. When used in a LAN networking environment, computing device 105 is connected to LAN 161 through network interface 155. When used in a WAN networking environment, computing device 105 can include modem 153 or other means for establishing communications over WAN 162, such as the Internet. While modem 153, which may be internal or external to computer 105, is shown connected to system bus 165 via serial port interface 150, it may be connected in a variety of other ways. In a networked environment, program modules, or portions thereof, may be stored in a remote memory storage device. It will be appreciated that the network connections shown are exemplary and other means of establishing a communications link between computer 105 and remote computer(s) 160 may be employed.

While it is envisioned that numerous embodiments of a platform independent ecosystem for the creation, consumption and trade of user generated digital content are particularly well-suited for computerized systems, nothing in this document is intended to limit a platform independent ecosystem for the creation, consumption and trade of user generated digital content to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

A platform independent ecosystem for the creation, consumption and trade of user generated digital content implemented in, for example, computer 105 can be implemented in connection with hardware, firmware or software or a combination thereof. Thus, the methods, apparatuses and systems for a platform independent ecosystem for the creation, consumption and trade of user generated digital content, or certain aspects or portions thereof, can take the form of program code (i.e., instructions) and/or data embodied in tangible computer readable media, such discrete or embedded memories such as hard disk drives, magnetic disks, optical disks, USB devices, ROM memories, flash memories, eFuses or any other machine-readable storage medium, wherein, when the program code or data is loaded into and executed or read by a machine, such as computer device 105, the machine becomes an apparatus for implementing a platform independent ecosystem for the creation, consumption and trade of user generated digital content. The program(s) can be implemented in assembly or machine language, if desired. In any case, the language can be a compiled or interpreted language, and combined with hardware implementations. The methods and apparatuses for implementing a platform independent ecosystem for the creation, consumption and trade of user generated digital content also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like. When executed by a processor, the program code combines with the processor to provide a unique apparatus that operates to invoke the functionality of a platform independent ecosystem for the creation, consumption and trade of user generated digital content. Additionally, any storage techniques used in connection with a platform independent ecosystem for the creation, consumption and trade of user generated digital content can invariably be a combination of hardware, firmware and software.

Exemplary Closed Computing Environment

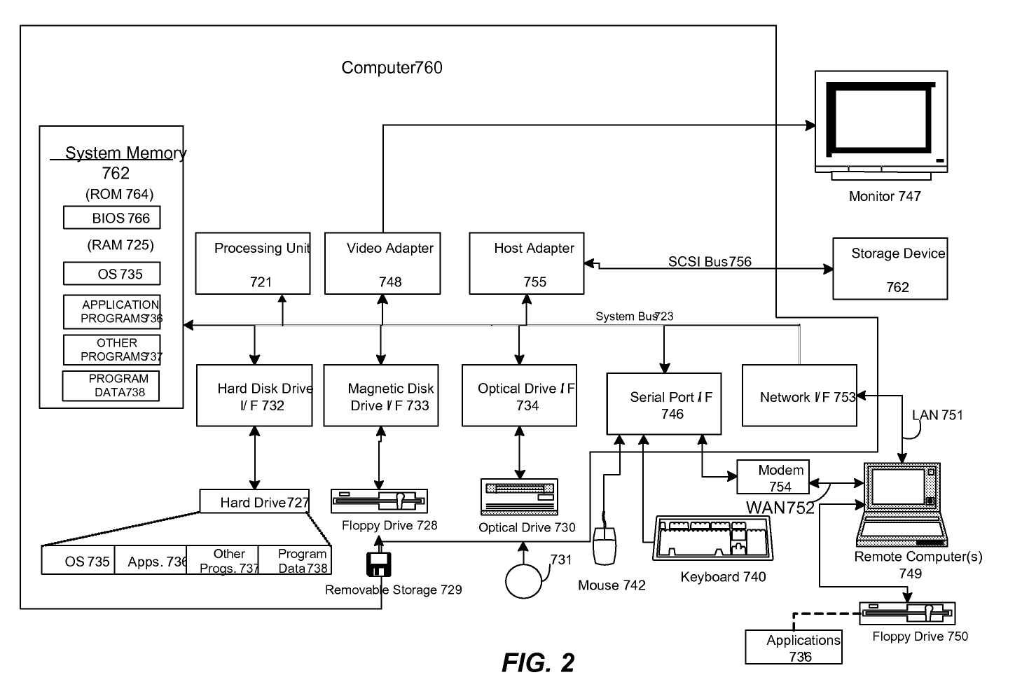

Without limitation, FIG. 2 is a block diagram of an exemplary closed computing environment in which various aspects of a platform independent ecosystem for the creation, consumption and trade of user generated digital content can be implemented. Closed computing devices tend to be more specialized, or have at least one specialized purpose, relative to general purpose computing devices. Closed systems tend to have one or more specific purpose(s) designed to execute, perhaps in addition to general programs, privileged programs specifically created for them. Examples of closed systems may include, for example, cable set top boxes, smart phones, gaming consoles such as Microsoft's Xbox 360 and cellular telephones that execute one or more privileged programs. As an example of what makes the Xbox 360 a closed computing environment, at least in part, is that it is designed to gain restricted access to services such as Xbox LIVE and Xbox LIVE Marketplace located at http://www.xbox.com. Xbox, Xbox 360 and Xbox LIVE are registered trademarks of Microsoft Corporation, One Microsoft Way, Redmond, Wash. 98052-6399. Xbox LIVE is a full spectrum online gaming and entertainment service. Besides providing online multiplayer gaming, through Xbox Live and Xbox LIVE Marketplace, customers can download purchased and promotional content to their Xbox 360, including high definition and standard definition television shows, movies, gaming videos, music videos, short feature films, video games, dashboard themes, slideshows, gamer pictures, game trailers/demos, movies, game content such as new maps, weapons, levels, characters, challenges, expansions, arcade games, demos and trailers.

FIG. 2 is a block diagram of an Xbox 360 gaming console. Game console 200 comprises hardware, firmware and software. Came console 200 comprises a computer system. Game console 200 executes game applications and plays generic and specialized media files (not shown). For purposes of simplicity, not all components or interconnectivity are shown and some components have been merged in exemplary game console 200. Game console 200 comprises central processing unit (CPU) 201, which has multiple CPU cores 202, 203, 204, each having embedded cache such as level 1 (L1) cache 208. CPU 201 further comprises level 2 (L2) cache 205, ROM (Read-Only Memory) 206 and fuses 207. CPU cores 202, 203 and 204 may share L2 cache memory 205. Level 1 and Level 2 cache 208, 205 temporarily store executable instructions and/or data, thereby improving processing speed and throughput. ROM 206 may store firmware such as BIOS or other initialization programs and data loaded during an initial phase or stage of a boot process such as when game console 200 is initially powered on. Alternatively, or in addition, the BIOS or other initialization programs and data loaded during one or more initialization phases/stages can be stored in another type of non-volatile memory such as flash (a type of EEPROM) memory, as may be represented by system memory 243, or fuses 207. In some embodiments, fuses 207 may be electronically programmable. In some embodiments, ROM 206, fuses 207, and alternative non-volatile memory storing initialization programs and/or data need not be embedded within CPU 201. However, physically locating memory devices that store initialization programs or data in CPU 201 may offer an added layer of security for such information. Game console 200 may optionally be a multi-processor system. For example, game console 200 may have three processors that are similar or dissimilar to processor 201.

Game console 200 further comprises graphics processing unit (GPU) 209, which is coupled to CPU 201, and any additional processors, by a bus. GPU 208 is also coupled by one or more busses each to memory controller 210, I/O (input/output) hub 218 and video codec (coder/decoder) 214. Memory controller 210 and video codec 214 may form part of GPU 209. GPU 209, in addition to video processing functionality, may comprise functionality commonly referred to as Northbridge. Northbridge functionality generally comprises a high speed memory and video hub having a memory controller and a video controller. In exemplary game console 200, both CPU 201 and I/O hub (Southbridge) 218 access main memory 212 through Northbridge functionality in GPU 209. Memory controller 210 facilitates access to various types of main memory 212, which may be RAM (Random Access Memory) or other variety of memory.

GPU 209 and video codec 214 together form a video processing pipeline for high speed, high resolution graphics processing required by many game applications. Data is carried from GPU 209 to/from video codec 214 via a bidirectional bus. This video processing pipeline outputs data to A/V (audio/video) port 240 for transmission to a television or other video display device (not shown). Game console 200 may have its own integrated display (not shown). Not shown is a digital to analog converter (DAC) that may be coupled between video codec 214 and A/V port 240.

Game console 200 further comprises I/O hub 218, which may comprise, among other functionality, functionality commonly referred to as Southbridge. Southbridge functionality generally performs and controls functions that are relatively slow compared to functions performed and controlled by Northbridge. I/O hub 218 comprises I/O controller 220, system management controller 222, audio processing unit 223, network interface controller 224, USB host controllers 226, 228 and front panel I/O subassembly 230. USB controllers 226, 228 serve as hosts for peripheral controllers 242(1), 242(2), wireless adapter 248, and memory unit 246 (e.g., flash memory, CD/DVD ROM, hard drive, other removable media). Network interface 224 and/or wireless adapter 248 provide access to a network (e.g., LAN, WAN or Internet) and may be any of a wide variety of various wired or wireless interface components including an Ethernet card, modem, Bluetooth module, and the like.

System memory 243 may be volatile and/or non-volatile memory, including flash memory. In some embodiments system memory 243 may store all or a portion of the initialization program and data (e.g. various boot loader stages) and operating system that is loaded during the initialization boot process. In other embodiments, system memory 243 may store application data, game saves and downloads. Media drive 244 may comprise, for example, a DVD/CD drive, hard drive or other fixed or removable media reader and/or writer. Game application data may be read from and/or written to media via media drive 244 for execution, playback, etc. by game console 200. Media drive 244 is connected to I/O controller 220 via a bus, such as a Serial ATA bus or other high speed connection (e.g., IEEE 5394). Game console 200 may include hard disk 252, which may be used, for example, to store all or a portion of the initialization program and data (e.g. various boot loader stages) and operating system that is loaded during the initialization boot process, game applications, game data or other types of data.

System management controller 222 provides a variety of service functions for game console 200. Audio processing unit 223 and audio codec 232 form a corresponding audio processing pipeline that may provide high fidelity, 5D, surround, and stereo audio processing of sounds produced by, for example, a game application. Audio data is carried between audio processing unit 223 and audio codec 232 via a communication link. The audio processing pipeline outputs audio data to A/V port 240 for implementation by a device having audio capabilities.

Front panel I/O subassembly 230 supports the functionality of various controls such as power button 250 and eject button 252, as well as any LEDs (light emitting diodes) or other indicators exposed on the outer surface of game console 200. System power supply module 236 provides power to components of game console 200 while fan 238 cools them.

CPU 201, GPU 209, memory controller 210, and various other components within game console 200 are interconnected via one or more buses, including serial and parallel buses, a memory bus, a peripheral bus, and a processor or local bus using any of a variety of bus architectures. As previously noted, not all buses or other connections and components are shown in FIG. 2.

When game console 200 is powered on or rebooted, aside from initialization, application data and/or instructions can be loaded from system memory 243, media drive 244, hard disc 253 or other memory into main memory 212 and/or caches 205, 208 and executed on CPU 201. The game application being executed may present a graphical user interface that provides a consistent user experience when navigating to different media types available on or to game console 200. Instructions and/or data accessible via media drive 244, system memory 243, hard disk 253 or other memory may be launched, played or otherwise accessed from these various sources to provide additional functionality to game console 200.

Game console 200 may be operated as a stand alone system by connecting the system to a television or other display. As previously noted, game console 200 may have an integrated display. In this stand alone mode, game console 200 may allow one or more users to interact with the system, watch movies, listen to music, play games and the like. Network interface 224 or wireless adapter 248 may allow game console 200 to be operated as a participant in a local or wide area network community such as Xbox LIVE.

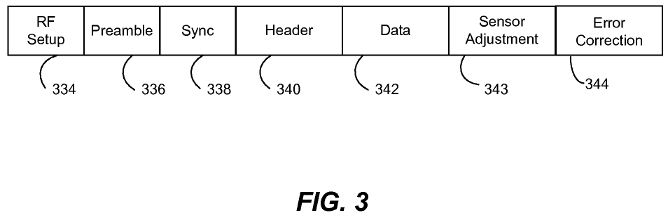

An exemplary embodiment of a platform independent ecosystem for the creation, consumption and trade of user generated digital content will be now be discussed with respect to FIG. 3. Although the embodiment refers to exemplary game console 200, the embodiment and a wide variety of other embodiments have applicability to exemplary computing system 100, exemplary game console 200 and other computing environments.

FIG. 3 is a diagram illustrating various aspects of a platform independent ecosystem for the creation, consumption and trade of user generated digital content in accordance with one embodiment thereof. In the embodiment depicted by FIG. 3, the architecture of ecosystem 300 comprises user computing device 305, application 310, authentication service 320, identity storage 330, digital object service 340, digital object registration service 350, digital object commerce listing service 360, atomic object exchange service 370, digital object storage 380, digital object metadata storage 390 and commerce object state storage 395. Ecosystem 300 in its entirety, or portions of it, may be implemented anywhere on the Web, such as on or through the Xbox LIVE service or other trusted services that authenticate credentials. Authentication may be centralized or distributed. User 305 comprises, for example, a human interacting with a computing device such as computing system 100 or game console 200. As illustrated by application 310, user computing device 305 executes application 310, which a user interacts with. User computing device 305 provides user input 306 to application 310, which generates user output 307, e.g., presented to user by display 126. A human interacting with user computing device 305 may interact with application 310 to create UGDOs, register UGDOs on the trading system, browse listings of UGDOs, acquire UGDOs, or otherwise interact with ecosystem 300.

Application 310 participates in ecosystem 310 by adaptation or through original design, making use of a well-defined interface to system 300. Application 310 may comprise an application or suite of applications that is (are) local (native), managed or network (remote), e.g. LAN or WAN including a Web-based (e.g. online, multi-player game). For example, application 310 may be a video game client, video game server, user controlled authoring application such as a map editor or video mastering tool, automated authoring application or any other application or suite of applications that may, together, participate in ecosystem 310. Application 310 may represent more than one application such as when one application is used to create or use UGDOs and another is used to interact with the trading system involving the UGDOs. Even though well-defined interfaces are available to all applications, not all vendors may adapt all applications to interface to the trading system. Application 310 may comprise a combination or suite of applications such as an Internet browser (e.g. Microsoft Internet Explorer) to interact with the trading system, UGDO player (e.g. Windows Media Player) to utilize UGDOs and UGDO authoring/utilization application (e.g. Microsoft Word) to create and/or utilize UGDOs. The trading system is independent of (i.e. external to) all other applications (e.g. game titles). The trading system provides heterogeneous application support by offering well-defined programming interfaces so that any application (e.g. Halo 3 and Call of Duty 4 game titles) operating on any platform (e.g. Microsoft's Xbox, Sony's Playstation) can participate in the trading system. Further, the metadata attribution method facilitates participation by a wide variety of applications in a UGDO economy. Thus, any application can participate in the market for UGDOs.

Authentication service 320 authenticates users 305 and applications 310 for ecosystem 300. Authentication service 320 receives credentials from user 305 and/or application 310 and verifies them against stored credentials. Credentials may be stored in Identity storage 330. Identity storage 330 may store information about all known users and applications and their credentials for purposes of identity and associated rights verification. If authentication service 320 verifies credentials provided by user 305 and/or application 310, then authentication service 320 generates and provides one ore more tickets (e.g. signed binary large object or BLOB), tokens or other unique identifiers, which may be utilized by user 305 and/or application 310 to verify identity and associated rights. In some embodiments, authentication service 320 may use a network authentication protocol such as Kerberos, developed by the Massachusetts Institute of Technology (MIT). Authentication service 320 may be distributed among trusted authentication services such as Xbox LIVE. For example, the Xbox LIVE service may provide all or a portion of the functionality of authentication service 320 and identity storage 330.

Digital object service 340 interfaces to users 305 and applications 310. Digital object service 340 may perform a wide variety of general services. For example, digital object service 340 may service requests to create new objects, retrieve objects attributed to a particular user, retrieve the status of objects and write or locate metadata to or for particular objects, among other requests. Digital object service 340 may verify credentials prior to servicing certain or all requests. Digital object service 340 may also transform data for adaptation to different platforms and architectures.

Digital object registration service 350 implements a metadata attribution methodology applied to UGDOs when they are ingested into the trading system and when they need to be updated, such as for commercial transactions that change rights in UGDOs. This metadata attribution permits reuse of objects by applications other than those used to generate the objects. This adds value for UGDO producers, application developers and consumers by expanding the marketability/applicability of digital property to additional applications and consumers. As illustrated in FIG. 3, digital object registration service 350 handles requests from digital object service 340 by retrieving existing objects from object storage 380, writing new objects to object storage 380 and maintaining metadata about objects in metadata storage 390. All digital objects are stored in digital object storage 380 upon their ingestion into trading system 300. Digital objects may be retrieved from digital object storage 380 to the extent the requesting user and/or application have rights to them. All metadata associated with each object is stored in digital object metadata storage 390. Metadata may include, for example, owner identification, creation date and time stamps, last usage date and time stamps, various text tags for indexing and searching, user access control lists, expiration dates, version numbers, applications that can use objects, globally unique identifiers (GUIDs), unique identifiers for other applications, content type declarations (e.g. text, images, animations, video), tags or labels, categories and other useful information (e.g. thumbnail images or icons) used to describe or present objects to users in the trading system. Metadata may be separated into a plurality of files, e.g., by topic such as UGDO content, rights, etc., or it may be a single file. Metadata may also identify groups of objects that may be related in some way, e.g., a group of objects that may form a set. Digital object registration service 350 is also responsible for enforcing all access requests by other trading system components to objects stored in digital object storage 380 based on the access control policies/rights specified by metadata associated with the objects.

Digital object registration service 350 may also be used, at least in part, to implement the UGDO ownership and other rights enforcement model. The enforcement model provides flexible enforcement rules that may be specified in metadata stored in metadata storage 390. The nature of enforcement may depend, for example, on the nature of UGDO content. Digital Rights Management (DRM) techniques may be applied to passive content (e.g. music, video) mainly used offline or requiring participation of only one consumer, as opposed to interactive content (e.g. an avatar in a multi-player game). In contrast, a server-controlled ownership model may be used for active content. A server agent (e.g. in applications such as application 310) may perform access control checks per user prior to UGDO access and/or use. Server agents (e.g. in applications) may also ultimately enforce rules specified in metadata. Digital object registration service 350 and/or other components of system 300 may also provide enforcement of rules specified in the metadata.

Digital object commerce listing service 360 and atomic object exchange service 370 implement the fair exchange service in part by supporting a wide variety of transactions, including those involving more than two parties. The trading system supports flat fee purchases, licensing, auctions, bartering, trades, etc. The trading system assures that all varieties of the UGDO economy are secure, fault tolerant and atomic. These characteristics of the trading system expand the marketability and value of digital property. Digital object commerce listing service 360 facilitates the posting of new items in the commerce system and advertises objects for exchange in the trading system 300. Digital object commerce listing service 360 permits applications to enumerate items that are available for various exchange scenarios. Digital object commerce listing service 360 may store and retrieve objects and accompanying listing information from commerce object state storage 395. The state of all objects in the trading system is stored in commerce object state storage 395. For example, objects may be referenced as available for direct sale, trade and/or auction, among other possible and permitted exchanges. Digital object commerce listing service 360 may also access and use metadata about objects stored in digital object metadata storage 390 for use in the listing service.

Atomic object exchange service 370 may be a storefront providing a fair exchange service across applications and platforms. Atomic object exchange service 370 facilitates trades, purchases, auctions and other possible and permitted transactions that are made available through commerce listing service 360. Atomic object exchange service 370 verifies that the transfer of rights in transactions is atomic, i.e., guarantees that transactions either occur to completion or do not occur and have no effect whatsoever. Atomic object exchange service 370 may access commerce object state storage 395 to accomplish transactions. Commerce object state storage 395 may store data used to control the state of bids, offers and other messaging amongst users for purposes of atomic object exchange service 370.

Having described the exemplary components in the exemplary architecture of system 300, exemplary details of their interconnectivity and interaction will be discussed. Some, though not all, communication between components is illustrated in FIG. 3. As but one example of communication links not shown in FIG. 3, commerce listing service 360 may communicate with registration service 350, e.g., to verify that a user has rights to list an object for sale. With regard to each communication channel (connection) between components that is shown and not shown, it should be understood that the underlying connections between components may be any form of connection, whether localized (e.g. within the same computer system or coupled by a local cable) or remote (e.g. LAN, WAN). Each of the components themselves may be centralized or distributed among a plurality of components and subcomponents communicatively coupled by any variety of local or remote connection. The components of system 300 may be within one or more computing systems. The purpose of dashed line 399 is to indicate that in some embodiments application 310, beyond being configured to participate in system 300, may include a component of system 300 such as a server side agent to enforce rights in UGDOs.

As illustrated in FIG. 3, user 305 interacting with a computer system communicates with application 310. User 305 provides input 306 to application 310, which provides output 307 to user 305. Application 310 communicates with authentication service 320, digital object service 340, commerce listing service 360 and object exchange service 370. Application 310 may submit credentials 311 to authentication service 320, which responds by denying credentials or returning a ticket or unique identifier 312. Authentication service 320 may make requests 321 from user and application identity storage 330, which responds by returning 322 requested information. Application 310 may submit or request an object 313 to digital object service 340, which responds 314 by returning a requested object, its metadata or the state of an operation such as the success or failure of submitting an object. Application 310 may post or seek to browse objects/items 315 via commerce listing service 360, which responds 316 with the status of an operation such as posting a new object or items sought to be browsed. Application 310 may initiate an exchange 317 with exchange service 370, which responds 318 with the status of the exchange.

Digital object service 340, responsive to communications with application 310, may supply or request 341 objects or metadata to/from object registration engine 350, which responds 342 with the state of an operation such as ingesting new objects or the requested object or metadata. Responsive to digital object service 340, digital object registration engine 350 accesses 351 object storage 380 to store or request an object, to which object storage 380 responds 352 with a status of a storage operation or the requested object. Responsive to digital object service 340, object registration engine 350 accesses 353 metadata storage 390 to store or request metadata, to which metadata storage 390 responds 354 with a status of a storage operation or the requested metadata.

Digital object commerce listing service 360, responsive to communications with application 310, may request 361, and in some embodiments supply, metadata from/to metadata storage 390, which responds 362 with the requested metadata, or state of an operation such as writing metadata. Responsive to communications with application 310, digital object commerce listing service 360 may access commerce object state storage 395 to read 364 or write 363 object state information, to which commerce object state storage 395 responds with a status of a write operation or the requested state information. Responsive to communications with application 310, atomic object exchange service 370 may access commerce object state storage 395 to read 372 or write 371 object state information, to which commerce object state storage 395 responds with a status of a write operation or the requested state information.

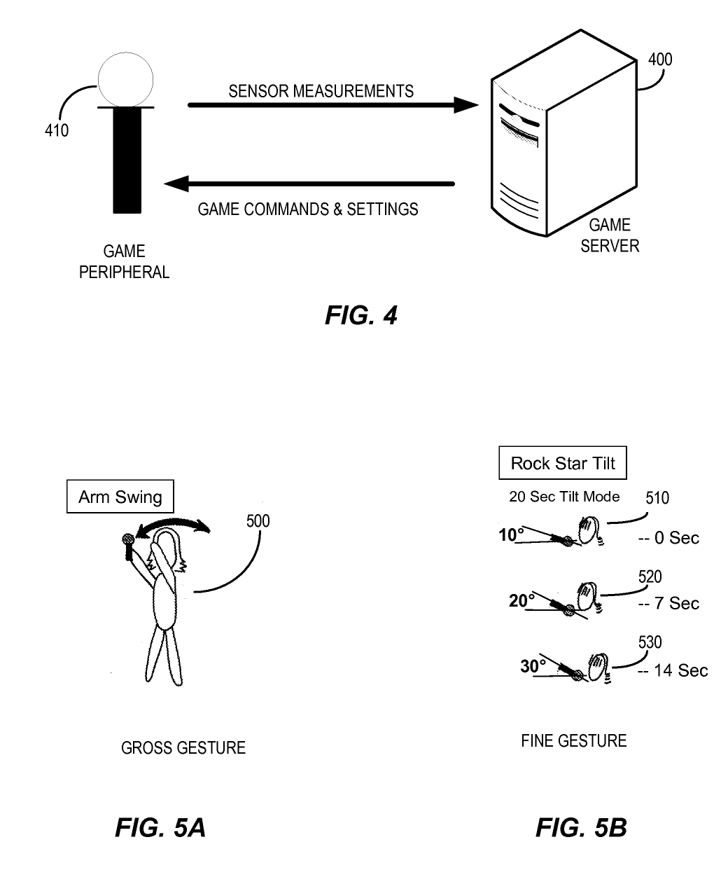

FIG. 4 is a content ingestion flow diagram illustrating various aspects of a platform independent ecosystem for the creation, consumption and trade of user generated digital content in accordance with one embodiment thereof. FIG. 4 illustrates an exemplary content ingestion flow relative to the exemplary trading system architecture illustrated in FIG. 3. It will be observed that this exemplary content ingestion flow involves interaction between user computing device 305, application 310, authentication service 320, identity storage 330, digital object service 340, digital object registration service 350, digital object storage 380 and digital object metadata storage 390 in ecosystem 300. The flow begins with the creation of a digital object 405. A digital object may be created by any application. For example, a user (e.g. Bob) 305, using a gaming console such as gaming console 200 executing an application 310 to create 405 an object. The application and object may be anything, such as a recording application that recorded Halo 3 game play on a gaming console with an alternative music track. Alternatively, the object may be an in-game Avatar, i.e., an object acting as a representation or embodiment of a user.

Once he has an object, i.e. UGDO, Bob may decide to upload and register the object to make it available through trading system 300. For example, Bob may sign on to Xbox LIVE through his gaming console 200. As part of this initial authorization process 410, Bob may provide information such as his username and password. The Xbox LIVE authentication service, and any other trusted service, may provide all or part of authentication service 320 and identity storage 330. Authentication service 320 looks up 415 Bob's account and generates 420 a ticket granting ticket (TGT) that can be used to acquire authentication credentials for target services. The TGT may contain, for example, Bob's IP (internet Protocol) address, a session key and an expiration stamp. In this instance, the desired or target services are from digital object service 340 to upload and register an object. The TGT is provided 425 to Bob's gaming console by authentication service 320. Bob may choose to act immediately to upload and register his object or to wait and do it later. However, the TGT has an expiration. If Bob waits too long, he will need to acquire another TGT. Whenever Bob chooses to act, and assuming the TGT remains valid, Bob's application 310 running on his gaming console sends 430 the TGT along with a request for a service ticket to Xbox LIVE or other service providing authentication service 320. Authentication service 320 responds by sending 435 a service ticket to Bob's application.

Once he has a service ticket to accompany his object, Bob uses application 310 to prepare and send 440 a message including the service ticket, object and an object policy request to digital object service 340. The service ticket authenticates the entire message to digital object service 340. The object policy request may specify some of the metadata to be associated with the object, e.g., object type, object rights. Upon receiving the message from application 310, digital object service 340, upon validation of the authentication token in the service ticket, forwards 445 the object and object policy request to digital registration service 350. Digital registration service 350 generates 450 metadata according to the object policy request, including additional metadata. Digital registration service 350 then stores 455 the object in digital object storage 380 and its associated metadata in metadata storage 390. In some embodiments, digital object registration service 350 may return to application 310, e.g. through digital object service 340, a ticket (e.g. a signed BLOB) with all metadata for review/recordation by application 310 and/or user 305. Access to the object will be enforced by registration service 350 according to its associated metadata. On successful or unsuccessful completion of content ingestion, the object metadata along with a status result of the operation is provided 465 to digital object service 340. In turn, digital object service 340 forwards 470 the object metadata and status result to the calling application 310.

An exemplary portion of metadata created 450 by registration service 350 may be as follows:

```
< DigitalObjectMetaData xmlns:xsi=″http://www.w3.org/2001/
XMLSchema-instance″
          xmlns:xsd=″http://www.w3.org/2001/XMLSchema″
          xmlns=″http://www.microsoft.com/ems/license″
          ObjType=”InGameObject”>
    <ObjectUniqueID>43384593846632q1</ObjectUniqueID>
    <ObjectUniqueHash>138dh9wkjd9s</ObjectUniqueHash>
    <ApplicationOriginID>uvmcoe4750e</ApplicationOriginID>
    <PublisherID>19buwwqp4r4a</PublisherID>
    <AuthorID>2048fkwp</AuthorID>
    <NumberOfAllowedObjectInstances>5
    </NumberOfAllowedObjectInstances>
    <AccessControlList>
        <User ID=”rit49wwq109gu5”>
              <ObjectRights>
                <AllowRead>True</AllowRead>
                <AllowPlay>True</AllowPlay>
                <AllowOverwrite>False</AllowOverwrite>
                <AllowSell>True</AllowSell>
            </ObjectRights>
        </User>
        <User ID=”3482tywk4258jfa2”>
              <ObjectRights>
                <AllowRead>True</AllowRead>
                <AllowPlay>True</AllowPlay>
                <AllowOfflinePlayWithoutRightsVerification>True
                </AllowOfflinePlayWithoutRightsVerification>
                <AllowOverwrite>False</AllowOverwrite>
                <AllowSell>False</AllowSell>
            </ObjectRights>
        </User>
    </AccessControlList>
</ DigitalObjectMetaData>
```

In the foregoing exemplary portion of metadata, it can be seen that the metadata in this embodiment is written in XML (Extensible Markup Language) with semantics set forth in a custom XML schema. The object type is “IngameObject” and it has been assigned a unique identifier “43384593846632q1.” Bob has been assigned an author identification “2048fwkp.” Bob has limited the number of instantiations of his object, i.e. transactions to acquire his object, to five. Under the access control list, there are two users, the first having user identification “rit49wwq109gu5” and the second having user identification “3482tywk4258jfa2.” The first user is permitted to read, play and sell the object, but not to overwrite the object. The first user may also use the object offline without the necessity of verifying rights to the object. The second user is permitted to read and use (e.g. play) the object, but is not permitted to overwrite or sell it. The user with sales rights, e.g., the first user, may also be the author, Bob. In some embodiments, resale rights may be acquired by those who acquire objects. In other embodiments, authors may assign their rights to others who will thereby acquire ownership rights.

By offering heterogeneous application support, any application can call digital object service 340 to ingest an object into system 300. Content ingestion into system 300 is external to participating applications. Metadata may permit interoperability of objects across various applications and versions of applications. Metadata may be understood and consumed by applications and versions of applications other than the application used to create the object. Metadata may be searched to narrow a field of objects, e.g., objects pertaining to a particular game title or authored by a particular user.

FIG. 5 is an exchange flow diagram illustrating various aspects of a platform independent ecosystem for the creation, consumption and trade of user generated digital content in accordance with one embodiment thereof. FIG. 5 illustrates an exemplary exchange flow relative to the exemplary trading system architecture illustrated in FIG. 3. It will be observed that this exemplary exchange flow involves interaction involving several user computing devices 305, several applications 310, authentication service 320, registration service 350, object listing service 360, atomic object exchange service 370 and digital object metadata storage 390 in ecosystem 300. The flow illustrated is actually two distinct transactions. The first transaction involves Bob, the author and seller of a registered object, who endeavors to list his registered object on commerce listing service 360. The second transaction involves Jim, a purchaser, who endeavors to find, select and purchase Bob's object on commerce listing service 360.

The first transaction begins with the creation and registration 501 of a digital object 405. See, e.g., FIG. 4 and accompanying discussion pertaining to Bob's exemplary creation and registration of an Avatar. Having registered the Avatar object, Bob may decide to list the object on commerce listing service 360 to make it available for exchange through trading system 300. Of course, rather than do it separately, Bob could engage in listing his object as part of the process of registering it. Assuming he does it separately, Bob may again sign on to Xbox LIVE through his gaming console 200. As part of the initial authorization process (not shown in FIG. 5), Bob may provide information such as his username and password. The Xbox LIVE authentication service, and any other trusted service, may provide all or part of authentication service 320 and identity storage 330. Authentication service 320 looks up (not shown in FIG. 5) Bob's account and generates (not shown in FIG. 5) a ticket granting ticket (TGT) that can be used to acquire authentication credentials for target services. The TGT may contain, for example, Bob's IP (internet Protocol) address, a session key and an expiration stamp. In this instance, the desired or target services are from digital object commerce listing service 360 to list the registered Avatar object. The TGT is provided (not shown in FIG. 5) to Bob's gaming console by authentication service 320. Bob may choose to act immediately to list his object or to wait and do it later. However, the TGT has an expiration. If Bob waits too long, he will need to acquire another TGT. Whenever Bob chooses to act, and assuming the TGT remains valid, Bob's application 310 running on his gaming console sends 505 the TGT along with a request for the desired service ticket for commerce listing service 360 to Xbox LIVE or other service providing authentication service 320. Authentication service 320 responds by sending 510 a service ticket for commerce listing service 360 to Bob's application.

Once he has a service ticket to commerce listing service 360, Bob uses application 310 to prepare and send 515 a message to commerce listing service 360 to list his object. The message may include the service ticket, object identifier (e.g. 43384593846632q1), price, terms of use and other pertinent information to be specified in the object's metadata. The service ticket authenticates the entire message to commerce listing service 360. Upon receiving the message from application 310, commerce listing service 360, upon validation of the authentication token in the service ticket, will seek to verify Bob's right to list the registered Avatar object for sale or otherwise in the commerce listing service 360. Assuming that the first user with sale rights in the foregoing metadata (i.e. user ID rit49wwq109gu5) refers to Bob, commerce listing service 360 will validate Bob's ownership rights permitting him to list the object. Commerce listing service 360 sends 520 Bob's user ID rit49wwq109gu5 in the security token of the service ticket, the object identifier 43384593846632q1 and the requested operation (i.e. list the object for sale) to registration service 350. Registration service 350 looks up (i.e. requests) 525 from metadata storage 390 access control/object rights metadata for the object having object ID 43384593846632q1. Metadata storage 390 returns 530 the requested access control/object rights metadata to registration service 350. Registration service 350 then performs 531 a permission check by comparing the information received from commerce listing service 360 to the information received from metadata storage 390. The result of the permission check is an object rights status. Registration service 350 sends 535 the object rights status to commerce listing service 360. Since Bob has the right to sell the Avatar object according to metadata associated with the object, object listing service 360 adds the object ID, price and other pertinent information to its catalog database (not shown) and returns 540 the result in a message to application 310, which may cause a display coupled to gaming console 200 to display the message to Bob.

The second transaction involving Jim, a purchaser, begins with, for example, Jim signing on to Xbox LIVE through his gaming console 200. When signing on, Jim may provide information such as his username and password. The Xbox LIVE authentication service, and any other trusted service, may provide all or part of authentication service 320 and identity storage 330. Authentication service 320 looks up (not shown in FIG. 5) Jim's account and generates (not shown in FIG. 5) a ticket granting ticket (TGT) that can be used to acquire authentication credentials for target services. The TGT may contain, for example, Jim's IP address, a session key and an expiration stamp. In this instance, the desired or target services are from object listing service 360 to browse objects and perhaps purchase one or more of them. The TGT is provided (not shown in FIG. 5) to Jim's gaming console by authentication service 320. Jim may choose to act immediately to browse and possibly purchase an object or to wait and do it later. However, the TGT has an expiration. If Jim waits too long, he will need to acquire another TGT. Whenever Jim chooses to act, and assuming the TGT remains valid, Jim's application 310 running on his gaming console sends 545 the TGT along with a request for a service ticket for commerce listing service 360 to Xbox LIVE or other service providing authentication service 320. Authentication service 320 responds by sending 550 a service ticket to Jim's application.

Once he has a service ticket to commerce listing service 360, Jim uses application 310 to prepare and send 555 a message including the service ticket and a request to browse objects to commerce listing service 360. The service ticket authenticates the entire message to commerce listing service 360. Upon receiving the message from application 310, commerce listing service 360, upon validation of the service ticket/security token, permits application 310 to browse objects by providing 560 object listing information to application 310. Jim decides to purchase Bob's Avatar object. Application 310 prepares and sends 565 a message to commerce listing service 360 including the object ID of the Avatar, the desired operation (purchase) and the service ticket. Commerce listing service 360 validates the security token, looks up the object in the catalog and sends 570 a request on Jim's behalf to atomic object exchange service 370. The request includes Jim's user ID from the security token, object ID, seller's ID and a request to purchase operation.

Responsive to the request from commerce listing service 360, atomic object exchange service 370 performs the final steps towards completing the purchase transaction. Object exchange service 370 may freeze 371, although not transfer, funds in Jim's account or otherwise verify payment, e.g., by obtaining credit card pre-authorization, while proceeding towards completion. Object exchange service 370 requests 575 object metadata from metadata storage 390, which returns 580 the requested metadata. Object exchange service 370 modifies the metadata to reflect the nature of the exchange, e.g., exclusive license, non-exclusive license, ownership assignment. In this example, Jim may be listed in the forgoing metadata as user ID 3482tywk4258jfa2 having rights to read and play (use) the Avatar object. In the case of a trade other than cash payment, metadata for more than one object may be involved and multiple users, e.g., both Bob and Jim, may need to actively participate to complete a transaction. Following modification of the metadata, object exchange service 370 writes (updates) 585 the metadata stored in metadata storage 390, the status (success or failure) of which is provided 590 by metadata storage 390 to object exchange service 370. In some embodiments, updating metadata may be done directly by atomic object exchange service 370 or through other components such as object registration engine 350. Upon confirmation that the metadata reflects the transaction, object exchange service 370 transfers 591 the frozen or preapproved funds and provides 595 the status of the transaction to the purchaser's (Jim's) application 310. Exchange service 370 supports rollback of the transaction if any one of the foregoing steps in the transaction fail. Disbursement of funds and fees may be subject to the policies for system 300.

By offering heterogeneous application support, any application can call digital object commerce listing service 360 to participate in exchanges supported by listing and exchange services 360, 370 in system 300. Listing and exchange services occur external to participating applications. Metadata may permit interoperability of objects across various applications and versions of applications. Metadata may be understood and consumed by applications and versions of applications other than the application used to create the object.

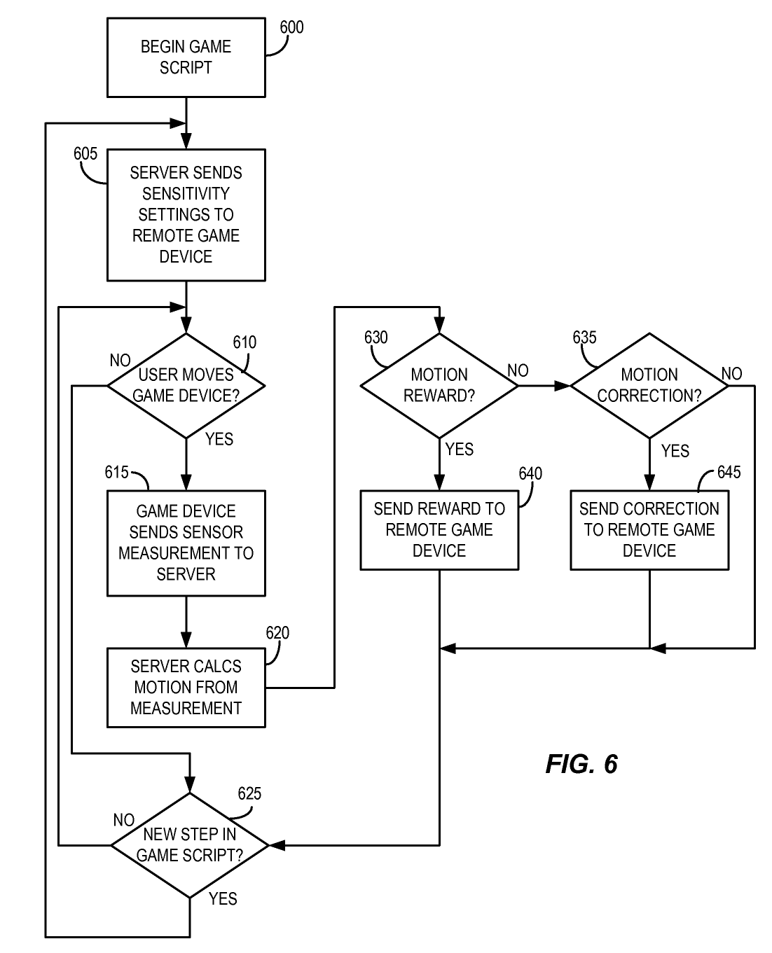

FIG. 6 is a rights verification flow diagram illustrating various aspects of a platform independent ecosystem for the creation, consumption and trade of user generated digital content in accordance with one embodiment thereof. FIG. 6 illustrates an exemplary rights verification flow relative to the exemplary trading system architecture illustrated in FIG. 3. It will be observed that this exemplary exchange flow involves interaction involving user computing device 305, application 310, authentication service 320, identity storage 330, digital object service 340, digital object registration service 350 and digital object metadata storage 390 in ecosystem 300. The exemplary flow may be utilized, for example, when a purchaser attempts to use an object acquired through system 300.

Although scenarios are limitless, a specific scenario will be described as an example. Assume that Jim (i.e. user ID 3482tywk4258jfa2 in the foregoing metadata segment) purchased a digital object (e.g. a custom car) from the system 300 through the Forza Motorsport™ game (application). Forza Motorsport is a registered trademark of Microsoft Corporation, One Microsoft Way, Redmond, Wash. 98052. Assume that the foregoing metadata segment refers to Jim's rights in the custom car object. The metadata describes Jim's rights as permitting use of the custom car object while playing offline without obtaining rights verification. However, since there is no provision about online play, a default requires Jim to obtain rights verification to use the custom car online, e.g., against other players. Therefore, assume that the exemplary flow in FIG. 6 involves the Forza Motorsport game performing online rights verification and enforcement of the rights specified in metadata associated with the custom car object. It is notable that this approach contrasts with common DRM approaches, which are also feasible in other embodiments.

The flow illustrated in FIG. 6 begins with Jim's attempt to use the custom car object in the Forza Motorsport game 310 in an online, multiplayer environment. The custom car object is loaded, but an online rights verification/permission check 605 is required to proceed. Jim, having successfully signed onto Xbox LIVE previously or presently, already has a TGT. Bob's application 310, which may be a web-based online multi-player version of Forza Motorsport, sends 610 a message to authentication service 320 comprising the TGT and a service request from digital object service 340. Authentication service 320 responds by sending 615 a service ticket for digital object service 340 to Bob's application. Bob's application 310 composes and sends 620 a message to digital object service 340 including the service ticket and an object permission request that includes the object ID for the custom car object. The service ticket authenticates the entire message to digital object service 340. Upon receiving the message from application 310, digital object service 340, upon validation of the authentication token in the service ticket, forwards 625 the object and object permissions request to digital registration service 350. Digital registration service 350 looks up (requests) 630 metadata in metadata storage 390 for the custom car object according to the object ID received from digital object service 340. Metadata storage 390 provides 635 the requested metadata, including the object rights element, to digital object registration service 350. In turn, object registration service 350 sends 645 the requested metadata to the requesting application 310, i.e., the online multi-player Forza Motorsport game. In some embodiments, digital object registration service 350 may return to application 310 such as the online multi-player Forza Motorsport game, e.g. through digital object service 340, a ticket (e.g. a signed BLOB) with all metadata for review/recordation by application 310 and/or user 305. The Forza Motorsport game enforces 650 the rights policy specified in the metadata for the custom car object. In this case, having verified the rights of Jim to use the object, the Forza Motorsport game permits Jim to use the custom car object in an online, multiplayer game session.

By offering heterogeneous application support, any application can call digital object service 340 to verify permissions for objects in system 300. Server controlled ownership is external to participating applications. The server controlled ownership model is applied to “active” content having the greatest value in an online environment. For example, a special Avatar or car in a multi-player game. In a server controlled ownership model, a server side agent performs an access control check prior to object (i.e. UGDO) usage by a given user.

Exemplary functionality illustrated in FIGS. 3-6 for various aspects of a platform independent ecosystem for the creation, consumption and trade of user generated digital content have been simplified for purposes of discussion. Exemplary functionality illustrated in FIGS. 3-6, as well as many other embodiments, may comprise one or more software programs executed by one or more computing systems. A software program may include application software or system software such as firmware, utility, operating system, hypervisor or any other category of computer program comprised of instructions executable by a computing system.

There are numerous advantages to a platform independent ecosystem for the creation, consumption and trade of user generated digital content. For example, a platform independent ecosystem for the creation, consumption and trade of user generated digital content provides a common platform to enable everyone to participate in the generation, publication and commercialization of UGDOs irrespective of their application or the platform on which it operates. Attributed metadata may be understood and consumed across platforms and applications. Applications may interact with an object's metadata rather than the object itself. This creates a true economy in UGDOs, in contrast to splintered platform, application and/or version specific systems. All manner of portals may be built atop this multi-purpose trading system, each of which may but need not be platform and application independent. Flexible exchanges and flexible enforcement make the system universal for all UGDOs.

While a platform independent ecosystem for the creation, consumption and trade of user generated digital content has been described in connection with the example embodiments of the various figures, it is to be understood that other similar embodiments can be used or modifications and additions can be made to the described embodiments for performing the same functions of a platform independent ecosystem for the creation, consumption and trade of user generated digital content without deviating there from. Therefore, a platform independent ecosystem for the creation, consumption and trade of user generated digital content as described herein should not be limited to any single embodiment, but rather should be construed in breadth and scope in accordance with the appended claims.

What is claimed:

1. A universal system for exchanging and enforcing rights in user generated digital objects (UGDOs), the system comprising one or more computer readable storage mediums storing computer executable instructions that, when executed by one or more processors, perform a method comprising:
registering a first UGDO according to registration information received from a first authorized user operating a first computer system executing a first participating application;
listing the UGDO on a commerce listing service as available for at least one exchange scenarios according to listing information received from the first authorized user; and
storing the first UGDO and storing, independent of the first UGDO, first metadata comprising the registration and listing information including rights that one or more users have in the first UGDO.

2. The system in accordance with claim 1, the method further comprising:
receiving a request to complete a selected one of the at least one exchange scenarios from a second authorized user operating a second computer system executing a second participating application, the second participating application interacting with the commerce listing service;
transferring rights in the first UGDO to the second authorized user in accordance with the selected exchange scenario by updating the first metadata, creating first updated metadata, to reflect the rights of the second authorized user in the first UGDO.

3. The system in accordance with claim 2, wherein the second participating application cannot itself utilize the first UGDO, but a third application executed by the second computer system or a third computer system can utilize the first UGDO.

4. The system in accordance with claim 2, wherein the first computer system is a closed computing environment and the second computer system is an open computing environment.

5. The system in accordance with claim 2, wherein the first updated metadata specifies different rights for online use and offline use of the first UGDO.

6. The system in accordance with claim 5, wherein the second participating application enforces online use rights of the first UGDO by the second authorized user.

7. The system in accordance with claim 2, wherein the selected scenario comprises an exchange of rights in the first UGDO for rights in a second UGDO having associated second metadata indicating rights that one or more users have in the second UGDO, the method further comprising:
transferring rights in the second UGDO to the first authorized user in accordance with the selected exchange scenario by updating the second metadata, creating second updated metadata, to reflect the rights of the first authorized user in the second UGDO.

8. The system in accordance with claim 1, wherein the first metadata comprises extensible markup language (XML).

9. The system in accordance with claim 2, wherein the first authorized user is authenticated to use the system by a first authentication service and the second authorized user is authenticated to use the system by a second authentication service.
